(19) United States
(12) Patent Application Publication
(10) Pub. No.: US 2014/0074650 A1
(43) Pub. Date: Mar. 13, 2014

(54) PERSONALIZED CROSS-DOMAIN RECOMMENDER SYSTEM

(71) Applicant: Qloo, Inc., (US)

(72) Inventor: Alexander P. Elias, New York, NY (US)

(73) Assignee: QLOO, INC., New York, NY (US)

(21) Appl. No.: 13/781,297

(22) Filed: Feb. 28, 2013

Related U.S. Application Data
(60) Provisional application No. 61/605,689, filed on Mar. 1, 2012.

(51) Int. Cl. G06Q 30/06

(52) U.S. Cl. CPC G06Q 30/0631
USPC 705/26.7

(57) ABSTRACT

Cross-domain recommender systems comprising: a profile module for allowing a user to define preferences in a plurality of domains; a query module for allowing a user to request a recommendation in a target domain; a recommendation module for responding to a request by applying an algorithm to make one or more recommendations in said target domain using preferences defined in one or more non-target domains; and a display module for presenting said one or more recommendations to a user.

### CROSS-REFERENCE TO RELATED APPLICATIONS

This application claims the benefit of U.S. Application Ser. No. 61/605,689, filed Mar. 1, 2012, which is hereby incorporated by reference in its entirety.

### BACKGROUND OF THE INVENTION

Recommender systems (also known as recommendation platforms or engines) are information filtering systems that attempt to predict the degree of preference that a user would give to a product, service, event, person, or group. Current recommender systems include those for recommending movies based on previous movie ratings and movie watching behavior and music based on preferred music characteristics and listening behavior.

### SUMMARY OF THE INVENTION

Current systems for recommendations are deficient in that they require a user to input or indicate their tastes or preferences in an area in order to generate a recommendation within that area. In other words, previous systems do not effectively offer recommendations in an area (e.g., a domain, category, etc.) that is new a user based on their tastes or preferences in one or more different areas. There is a long-felt and unmet need for a personalized, cross-domain recommender system.

Accordingly, in one aspect disclosed herein are computer-implemented systems comprising: a digital processing device comprising an operating system configured to perform executable instructions and a memory device; a computer program including instructions executable by the digital processing device to create a personalized, cross-domain recommender comprising: a profile module for allowing a user to define preferences in a plurality of domains; a query module for allowing a user to request a recommendation in a target domain; a recommendation module for responding to a request by applying an algorithm to make one or more recommendations in said target domain using preferences defined in one or more non-target domains; and a display module for presenting said one or more recommendations to a user. In some embodiments, the profile module allows a user to define preferences by providing one or more nodes in each domain. In further embodiments, the nodes include metadata that enables indirect associations of preferences across domains. In still further embodiments, the metadata comprises an association between two or more nodes within a domain. In some embodiments, the profile module accesses user information from one or more external websites or networks to define preferences in each domain. In further embodiments, the profile module accesses user likes and dislikes from one or more external social networks to define preferences in each domain. In some embodiments, the recommendation module responds to a request by making one or more recommendations in the target domain using preferences defined in at least two non-target domains of a querying user. In some embodiments, the recommendation module responds to a request by making one or more recommendations in the target domain using averaged preferences defined in the profiles of a defined group of users. In some embodiments, the recommendation module responds to a request by making one or more recommendations in the target domain using preferences defined in the profile a user connected to a querying user. In some embodiments, the profile module allows a user to define preferences in a plurality of domains for one or more aliases. In further embodiments, the recommendation module responds to a request by making one or more recommendations in the target domain using preferences defined in an alias for a querying user. In some embodiments, the recommendation module responds to a request by making one or more recommendations filtered or sorted based on a querying user's location. In some embodiments, the personalized, cross-domain recommender is implemented as a web application. In some embodiments, the personalized, cross-domain recommender is implemented as a mobile application.

In another aspect, disclosed herein are non-transitory computer readable storage media encoded with a computer program including instructions executable by a digital processing device to create a personalized, cross-domain recommender comprising: a profile module for allowing a user to define preferences in a plurality of domains; a query module for allowing a user to request a recommendation in a target domain; a recommendation module for responding to a request by applying an algorithm to make one or more recommendations in the target domain using preferences defined in one or more non-target domains; and a display module for presenting the one or more recommendations to a user. In some embodiments, the profile module allows a user to define preferences by providing one or more nodes in each domain. In further embodiments, the nodes include metadata that enables indirect associations of preferences across domains. In some embodiments, the profile module accesses user information from one or more external websites or networks to define preferences in each domain. In further embodiments, the profile module accesses user likes and dislikes from one or more external social networks to define preferences in each domain. In some embodiments, the recommendation module responds to a request by making one or more recommendations in the target domain using preferences defined in at least two non-target domains of a querying user. In some embodiments, the recommendation module responds to a request by making one or more recommendations in the target domain using averaged preferences defined in the profiles of a defined group of users. In some embodiments, the recommendation module responds to a request by making one or more recommendations in the target domain using preferences defined in the profile a user connected to a querying user. In some embodiments, the profile module allows a user to define preferences in a plurality of domains for one or more aliases. In further embodiments, the recommendation module responds to a request by making one or more recommendations in the target domain using preferences defined in an alias for a querying user. In some embodiments, the personalized, cross-domain recommender is implemented as a web application. In some embodiments, the personalized, cross-domain recommender is implemented as a mobile application.

In another aspect, disclosed herein are computer-implemented systems comprising: a digital processing device comprising an operating system configured to perform executable instructions and a memory device; a computer program including instructions executable by the digital processing device to create a personalized, cross-domain recommender comprising: a profile module for allowing a user to define preferences in a plurality of domains; a query module for allowing a user to request a recommendation in a target domain; a recommendation module for responding to a request by applying an algorithm to make one or more recommendations in said target domain using preferences defined in one or more non-target domains; and a display module for presenting said one or more recommendations to a user. In some embodiments, a profile module allows a user to define preferences by providing one or more nodes in each domain. In further embodiments, a profile module allows a user to define preferences by providing at least two nodes in each domain. In still further embodiments, profile module allows a user to define preferences by providing at least three nodes in each domain. In still further embodiments, a profile module allows a user to define preferences by providing at least four nodes in each domain. In still further embodiments, a profile module allows a user to define preferences by providing at least five nodes in each domain. In some embodiments, nodes include metadata that enables indirect associations of preferences across domains. In further embodiments, metadata comprises an association between two or more nodes within a domain. In some embodiments, a profile module accesses user information from one or more external websites or networks to define preferences in each domain. In further embodiments, a profile module accesses user likes and dislikes from one or more external social networks to define preferences in each domain. In some embodiments, a recommendation module responds to a request by making one or more recommendations in said target domain using preferences defined in one non-target domain of a querying user. In some embodiments, a recommendation module responds to a request by making one or more recommendations in said target domain using preferences defined in two non-target domains of a querying user. In some embodiments, a recommendation module responds to a request by making one or more recommendations in said target domain using preferences defined in three non-target domains of a querying user. In some embodiments, a recommendation module responds to a request by making one or more recommendations in said target domain using preferences defined in four non-target domains of a querying user. In some embodiments, a recommendation module responds to a request by making one or more recommendations in said target domain using preferences defined in five non-target domains of a querying user. In some embodiments, a recommendation module responds to a request by making one or more recommendations in said target domain using averaged preferences defined in the profiles of a defined group of users. In some embodiments, a personalized, cross-domain recommender further comprises a networking module for allowing a user to connect to other users. In further embodiments, a recommendation module responds to a request by making one or more recommendations in said target domain using preferences defined in the profile a user connected to a querying user. In some embodiments, a profile module allows a user to define preferences in a plurality of domains for one or more aliases. In further embodiments, a recommendation module responds to a request by making one or more recommendations in said target domain using preferences defined in an alias for a querying user. In some embodiments, a personalized, cross-domain recommender further comprises a location module for determining a querying user's location. In further embodiments, a recommendation module responds to a request by making one or more recommendations filtered or sorted based on a querying user's location. In some embodiments, a personalized, cross-domain recommender is implemented as a web application. In some embodiments, a personalized, cross-domain recommender is implemented as a mobile application.

In another aspect, disclosed herein are non-transitory computer readable storage media encoded with a computer program including instructions executable by a digital processing device to create a personalized, cross-domain recommender comprising: a profile module for allowing a user to define preferences in a plurality of domains; a query module for allowing a user to request a recommendation in a target domain; a recommendation module for responding to a request by applying an algorithm to make one or more recommendations in said target domain using preferences defined in one or more non-target domains; and a display module for presenting said one or more recommendations to a user. In some embodiments, a profile module allows a user to define preferences by providing one or more nodes in each domain. In further embodiments, a profile module allows a user to define preferences by providing at least two nodes in each domain. In still further embodiments, a profile module allows a user to define preferences by providing at least three nodes in each domain. In still further embodiments, a profile module allows a user to define preferences by providing at least four nodes in each domain. In still further embodiments, a profile module allows a user to define preferences by providing at least five nodes in each domain. In some embodiments, nodes include metadata that enables indirect associations of preferences across domains. In further embodiments, metadata comprises an association between two or more nodes within a domain. In some embodiments, a profile module accesses user information from one or more external websites or networks to define preferences in each domain. In further embodiments, a profile module accesses user likes and dislikes from one or more external social networks to define preferences in each domain. In some embodiments, a recommendation module responds to a request by making one or more recommendations in said target domain using preferences defined in one non-target domain of a querying user. In some embodiments, a recommendation module responds to a request by making one or more recommendations in said target domain using preferences defined in two non-target domains of a querying user. In some embodiments, a recommendation module responds to a request by making one or more recommendations in said target domain using preferences defined in three non-target domains of a querying user. In some embodiments, a recommendation module responds to a request by making one or more recommendations in said target domain using preferences defined in four non-target domains of a querying user. In some embodiments, a recommendation module responds to a request by making one or more recommendations in said target domain using preferences defined in five non-target domains of a querying user. In some embodiments, a recommendation module responds to a request by making one or more recommendations in said target domain using averaged preferences defined in the profiles of a defined group of users. In some embodiments, a personalized, cross-domain recommender further comprises a networking module for allowing a user to connect to other users. In further embodiments, a recommendation module responds to a request by making one or more recommendations in said target domain using preferences defined in the profile a user connected to a querying user. In some embodiments, a profile module allows a user to define preferences in a plurality of domains for one or more aliases. In further embodiments, a recommendation module responds to a request by making one or more recommendations in said target domain using preferences defined in an alias for a querying user. In some embodiments, a personalized, cross-domain recommender further comprises a location module for determining a querying user's location. In further embodiments, a recommendation module responds to a request by making one or more recommendations filtered or sorted based on a querying user's location. In some embodiments, a personalized, cross-domain recommender is implemented as a web application. In some embodiments, a personalized, cross-domain recommender is implemented as a mobile application.

In another aspect, disclosed herein are computer-implemented methods for providing a cross-domain recommendation, the methods comprising: receiving a request from a user for a recommendation in a target domain (e.g., topic) based on the user's preferences in at least one non-target domain; indexing users who have defined one or more nodes (e.g., preferences, tastes, likes) in the target domain; counting the total number of nodes in the at least one non-target domain of the user requesting the recommendation; ranking the indexed users based on how many nodes they have in common with the requesting user in the at least one non-target domain; weighting each indexed user based on the ranking; adding each instance of a weighted node; and listing the top recommendations.

### BRIEF DESCRIPTION OF THE DRAWINGS

FIG. 1 shows a non-limiting example of a node for a first user in a music domain; in this case, a node associated with three levels of metadata, wherein each level is associated with a weight indicating the contained metadata's level of abstractness with respect the node. In this non-limiting example, a second user expressing a preference for “John Coltrane” would be an explicit match, while a second user expressing a preference for “Be-Bop” would be a level 1 metadata match, a second user expressing a preference for “McCoy Tyner” would be a level 2 metadata match, and a second user expressing a preference for “Jazz” would be a level 3 metadata match.

FIG. 2 shows a non-limiting example of application of an algorithm ranking hypothetical users for explicit matches to a hypothetical user “Jill” who has requested a recommendation for a bar in Manhattan based on her taste in music; in this case, an algorithm ranking each user associated with applicable data based on the number of nodes they have in common with Jill in the music domain adjusted for the proportion of each users' total nodes forming matches with Jill in the music domain.

FIG. 3 shows a non-limiting example of application of an algorithm collecting preferences for bars in Manhattan from select hypothetical users ranked in FIG. 2; in this case, a collection of preferences for bars in Manhattan weighted based on average of node scores determined by application of the algorithm of FIG. 2.

FIG. 4 shows a non-limiting example of application of an algorithm to recommend a bar in Manhattan; in this case, application of an algorithm using averaged unweighted preferences (e.g., both likes and dislikes) of a defined group of hypothetical users.

FIG. 5 shows a non-limiting example of application of an algorithm to recommend a bar in Manhattan; in this case, application of an algorithm using averaged weighted preferences (e.g., both likes and dislikes) of a defined group of hypothetical users.

### DETAILED DESCRIPTION OF THE INVENTION

Advantages of the systems, platforms, networks, applications, and methods described herein include the ability to offer recommendations in a target domain using preferences defined in one or more non-target domains (e.g., cross-domain recommendations). Additional advantages include the ability to offer recommendations using preferences defined in an alias for a querying user, using averaged preferences defined in the profiles of a defined group of users, and using preferences defined in the profiles of one or more connected users (e.g., friends, etc.).

Also described herein, in various embodiments, are computer-implemented systems comprising: a digital processing device comprising an operating system configured to perform executable instructions and a memory device; a computer program including instructions executable by the digital processing device to create a personalized, cross-domain recommender comprising: a profile module for allowing a user to define preferences in a plurality of domains; a query module for allowing a user to request a recommendation in a target domain; a recommendation module for responding to a request by applying an algorithm to make one or more recommendations in said target domain using preferences defined in one or more non-target domains; and a display module for presenting said one or more recommendations to a user.

Also described herein, in various embodiments, are non-transitory computer readable storage media encoded with a computer program including instructions executable by a digital processing device to create a personalized, cross-domain recommender comprising: a profile module for allowing a user to define preferences in a plurality of domains; a query module for allowing a user to request a recommendation in a target domain; a recommendation module for responding to a request by applying an algorithm to make one or more recommendations in said target domain using preferences defined in one or more non-target domains; and a display module for presenting said one or more recommendations to a user.

Also described herein, in various embodiments, are computer-implemented methods for providing a cross-domain recommendation, the methods comprising: receiving a request from a user for a recommendation in a target domain (e.g., topic) based on the user's preferences in at least one non-target domain; indexing users who have defined one or more nodes (e.g., preferences, tastes, likes) in the target domain; counting the total number of nodes in the at least one non-target domain of the user requesting the recommendation; ranking the indexed users based on how many nodes they have in common with the requesting user in the at least one non-target domain; weighting each indexed user based on the ranking; adding each instance of a weighted node; and listing the top recommendations.

### VARIOUS DEFINITIONS

Unless otherwise defined, all technical terms used herein have the same meaning as commonly understood by one of ordinary skill in the art to which this invention belongs.

As used in this specification and the appended claims, the singular forms “a,” “an,” and “the” include plural references unless the context clearly dictates otherwise. Any reference to “or” herein is intended to encompass “and/or” unless otherwise stated.

As used herein “domain” refers to an area of interest. For example, in various non-limiting embodiments, domains include “music,” “film,” “TV shows,” “restaurants,” “nightlife,” “travel destinations,” “books,” and “fashion brands” and the like.

As used herein “cross-domain” refers a recommendation in a target domain utilizing preferences defined in one or more non-target domains.

As used herein “topic” refers to sub-area of interest within a domain. For example, in a non-limiting embodiment, a film domain includes the topics “film actors,” “film directors,” “action films,” “horror films,” “comedy films,” and the like.

As used herein “node” refers to any element within a topic about which a user expresses an opinion. For example, in a non-limiting embodiment, a film director topic includes the nodes “Cecil B. DeMille,” “Woody Allen,” “Stanley Kubrick,” “Martin Scorsese,” and “Federico Fellini.”

As used herein “metadata” refers to data that describes other data. In some embodiments, metadata is data associated with nodes and describes the contents and context of nodes to allow indirect matching of nodes that are not explicit matches. For example, in a non-limiting embodiment, a node containing the content “John Coltrane” may be associated with the metadata “Be-Bop” and/or “Avant-garde Jazz.” In further embodiments, metadata exists in a plurality of levels, wherein the metadata in each level more abstract in its relationship to the node it describes than the metadata in the prior level.

As used herein “ether” refers to social networks and web sites external to the cross-domain recommender disclosed herein, from which opinions, such as likes and dislikes, associated with a known user are accessed.

### Personalized, Cross-Domain Recommender

The systems, platforms, networks, applications, and methods described herein, in some embodiments, create or provide a personalized, cross-domain recommender. In some embodiments, a computer program executed by a digital processing device creates or provided a personalized, cross-domain recommender. In some embodiments, a personalized, cross-domain recommender is provided by a web application accessed through a web browser executed on a processing device. In some embodiments, a personalized, cross-domain recommender is provided by an extension, plug in, add in, or add on to a web browser executed on a processing device. In other embodiments, a personalized, cross-domain recommender is provided by a standalone application accessed through a web browser executed on a processing device. In other embodiments, a personalized, cross-domain recommender is provided by a mobile application executed on a mobile processing device.

In some embodiments, a personalized, cross-domain recommender includes a profile module for allowing a user to define preferences in a plurality of domains. In some embodiments, a personalized, cross-domain recommender includes a query module for allowing a user to request a recommendation in a target domain. In some embodiments, a personalized, cross-domain recommender includes a recommendation module for responding to a request by applying an algorithm to make one or more recommendations in said target domain using preferences defined in one or more non-target domains. In some embodiments, a personalized, cross-domain recommender includes a display module for presenting recommendations to a user.

In some embodiments, a personalized, cross-domain recommender includes one or more databases or accesses one or more databases. In further embodiments, included or accessed databases include, by way of non-limiting examples, user preference and profile databases, user alias information, user network and connection databases, query databases, recommendation databases, and metadata databases. In some embodiments, a personalized, cross-domain recommender is Internet based. In some embodiments, a personalized, cross-domain recommender is cloud computing based. In other embodiments, a personalized, cross-domain recommender is intranet based. In some embodiments, a personalized, cross-domain recommender is based on computer readable storage media.

### Profile Module

The systems, platforms, networks, applications, and methods described herein, in some embodiments, include a user profile module to allow a user to define preferences in a plurality of domains as well as store preferences. In some embodiments, a domain is simply an area of interest. In further embodiments, a user expresses preferences with one or more domains. In various embodiments, a user profile module allows a user to define preferences in 1, 2, 3, 4, 5, 6, 7, 8, 9, 10, 11, 12, 13, 14, 15, 16, 17, 18, 19, 20 or more domains. In further various embodiments, a user profile module allows a user to define preferences in 20, 30, 40, 50, 60, 70, 80, 90, 100 or more domains, including increments therein. In still further various embodiments, a user profile module allows a user to define preferences in 100, 200, 300, 400, 500, 600, 700, 800, 900, 1000 or more domains, including increments therein.

In a various embodiments, non-limiting examples of domains include music, singers, bands, albums, films, actors, directors, comedians, travel destinations, books, poems, authors, poets, TV shows, restaurants, chefs, nightlife, bars, nightclubs, fashion brands, fashion designers, fragrances, cars, politicians, sports, sports teams, athletes, and the like. In a particular embodiment, non-limiting examples of domains include music, film, travel destinations, books, TV shows, restaurants, nightlife, and fashion brands.

In various embodiments, a user profile module facilitates definition of user preferences (e.g., tastes, favorites, likes, etc.) and stores user preferences through one or more distinct types of information. In further embodiments, each element about which a user expresses a preference or an opinion is a node. In some cases, a node is positive and represents a positive preference. In other cases, a node is a negative node and represents an aversion.

In some embodiments, a user inputs preference information. In further embodiments, a user profile module provides a graphic user interface (GUI) to facilitate user input of preference information. In still further embodiments, a user inputs preference information in the form of favorites or top picks in a domain or in a topic. In various embodiments, a user inputs preference information in the form of their top 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more favorites or top picks in a domain or in a topic. In some embodiments, a user inputs about 1 to about 10 top preferences in a domain or a topic. In a particular embodiment, a user inputs their top five preferences in a domain or a topic. Accordingly, in some embodiments, a user inputs about 1 to about 10 nodes in a domain or a topic and in a particular embodiment, a user inputs five nodes in a domain or a topic.

In some embodiments, preference information includes metadata associated with one or more nodes that describes the content of the node or expands the meaning and context for the content of the node. In further embodiments, metadata facilitates indirect matching of nodes that are not explicit matches, but have overlapping metadata. In some embodiments, the systems, platforms, networks, applications, and recommenders associate metadata with nodes by importing information from external sources. In further embodiments, a personalized, cross-domain recommender, or a software module thereof (e.g., a user profile module), culls information from external sources and applies natural language processing to associate metadata with the content of nodes. In some embodiments, metadata associated with each node is organized into levels, wherein each level of metadata contains information with a particular degree of relatedness, or conversely abstractness, with regard to the content of the node it describes. In various embodiments, metadata associated with a node is organized into 1, 2, 3, 4, 5, 6, 7, 8, 9, 10, 11, 12, 13, 14, 15, 16, 17, 18, 19, 20 or more levels. In further embodiments, each level of metadata is associated with a weight in a matching algorithm reflecting the degree of relatedness between the information in the level and the node it describes.

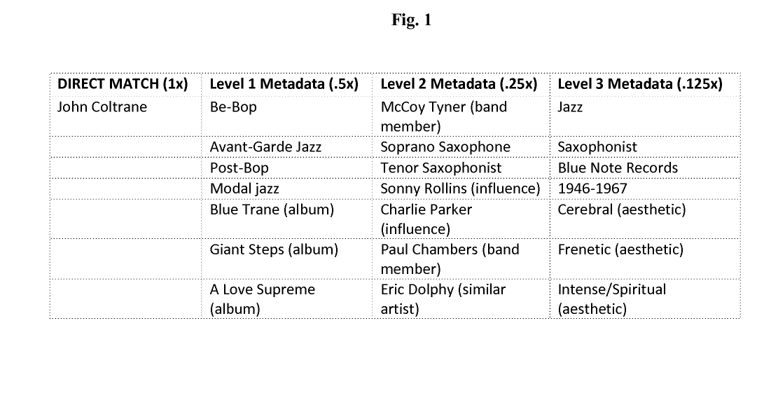

Referring to FIG. 1, in a particular non-limiting embodiment, a user has defined a node in a music domain. In this embodiment, the node contains “John Coltrane.” To match this user preference with that of a second user via an explicit match in a matching algorithm, the second user must also have defined a preference for “John Coltrane.” Such a direct match, in this embodiment, carries a weight of lx. Further in this embodiment, the node is associated with three levels of metadata, each level containing seven metadata that describe the content of the node and provide context and additional meaning Level 1 contains metadata most closely related to the node and carries a weight of 0.5x. Level 2 contains metadata less closely related to the node than that of level 1 and carries a weight of 0.25x. Level 3 contains metadata less closely related to the node than that of level 2 and carries a weight of 0.125x. To match this user preference with that of a second user via an indirect or metadata match in a matching algorithm, the second user must have defined a preference that is associated with metadata matching that associated with the metadata of the user of FIG. 1.

In some embodiments, preference information includes favorites, links, bookmarks, likes, dislikes, etc., expressed in external networks (e.g., websites, applications, services, etc.) and associated with a known user of the systems, platforms, networks, applications, and recommenders described herein. In further embodiments, a personalized, cross-domain recommender, or a software module thereof (e.g., a user profile module), utilizes application programming interfaces (API) provided by an external network or website to access user preference information. In various embodiments, suitable external networks and websites include, by way of non-limiting examples, Badoo, Bebo, Blogster, Buzzfeed, CafeMom, Classmates.com, Delicious, DeviantART, Digg, Diglo, Facebook, FARK, Flixster, Flickr, Fotolog, Foursquare, Friendfeed, Friends Reunited, Friendster, Google+, Habbo, Linkedln, Livejournal, Meetup, Mixi, Mylife, Myspace, MyYearbook, Netlog, Ning, Pingsta, Pinterest, Plaxo, Reddit, Slashdot, SoundCloud, Stumbleupon, Tagged, Tumblr, Tweetmeme, Twitter, Yammer, Yelp, and the like. In some embodiments, user preference information expressed in an external network is referred to as “ether.” In further embodiments, matches between the preferences of a first and second user based on ether is weighted in a matching algorithm. In still further embodiments, ether matches are weighted lower than explicit matches or metadata matches.

In some embodiments, a user profile module facilitates definition of user preferences in one or more aliases. In further embodiments, an alias allows a single user to define more than one set of preferences. Because recommendations are in part based on the defined preferences of a requesting user, defining alternative sets of preferences allows a user to customize, steer, skew, or manipulate recommendations. By way of non-limiting example, a user optionally elects to define a set of preferences under a first alias to tailor recommendations to their lifestyle on weekends and another set of preferences under a second alias to tailor recommendations to their lifestyle on weekdays.

### Query Module

The systems, platforms, networks, applications, and methods described herein, in some embodiments, include a query module for allowing a user to request a recommendation. In further embodiments, the recommendation modules and display modules described herein are activated in response to a user-initiated request for a recommendation (e.g., a query or the like). In still further non-limiting embodiments, a cross-domain recommender system comprising a query module is activated by a user's request for a recommendation (e.g., a user-initiated query).

In some embodiments, a query includes two components 1) an identification of the recommendation sought in a target domain 2) a non-target domain. By way of non-limiting examples, identification of the recommendation sought may be a science fiction novel (e.g., an identification of the recommendation sought in a book target domain) based on the requesting user's taste in music (e.g., a music non-target domain), a nightclub based on the requesting user's taste in clothing, or a sushi restaurant based on the requesting user's taste in movies. In some cases, a recommendation sought is location specific. By way of non-limiting examples, location specific recommendations include bars, restaurants, theaters, parks, beaches, concerts, performances, individual service providers, and the like. In other cases, a recommendation sought is location agnostic. By way of non-limiting examples, location agnostic recommendations include artists, songs, fashion brands, films, tablet computers, and the like.

In some embodiments, a query module provides a GUI for making queries to a user. In further embodiments, a GUI for making queries includes one or more features to facilitate use of common or consistent terms to input recommendations sought, target domains, and/or non-target domains. In further embodiments, features to facilitate use of common or consistent terms include, by way of non-limiting examples, drop down menus, word completion software modules, or auto complete software modules.

In some embodiments, the systems, platforms, networks, applications, and methods described herein, in some embodiments, include a query module for allowing a user to request a recommendation based on preferences defined in an alias profile or in a defined group profile. In some embodiments, a query module optionally allows a user to make an alias query. In further embodiments, a user defines preferences in one or more alias profiles as described herein. In still further embodiments, a query module provides a GUI with an element allowing a user to indicate one or more particular aliases for which to request the recommendation. In some embodiments, a query module optionally allows a user to make a group query. In further embodiments, a plurality of users optionally combine their defined preferences to jointly maximize their tastes to request a recommendation. In still further embodiments, a query module provides a GUI with an element allowing a user to indicate one or more groups for which to request the recommendation. In some embodiments, a group is defined by selecting particular users and/or user profiles or aliases. In other embodiments, a group is defined based on one or more rules. In various further embodiments, rules used to define a group include, connection or friend status in a social network or membership in a particular club, team, or association.

### Recommendation Module

The systems, platforms, networks, applications, and methods described herein, in some embodiments, include a recommendation module for responding to a request by applying an algorithm to make one or more recommendations in a target domain using preferences defined in one or more non-target domains. In various embodiments, a recommendation module makes recommendations in a target domain using preferences defined in 1, 2, 3, 4, 5, 6, 7, 8, 9, 10, 11, 12, 13, 14, 15, 16, 17, 18, 19, 20 or more non-target domains. In a particular embodiment, a recommendation module makes recommendations in a target domain using preferences defined in all non-target domains in which a user has defined preferences. In another particular embodiment, a recommendation module makes recommendations in a target domain using preferences defined in the non-target domain specified in the request for a recommendation.

In some embodiments, a recommendation module makes recommendations in a target domain using preferences defined in one or more non-target domains by matching users based on user preference information in the one or more non-target domains. In some embodiments, a recommendation module utilizes a plurality of classes and/or types of matches.

In some embodiments, suitable matches include explicit matches. In further embodiments, a recommendation module utilizes a plurality of types of explicit matching. In still further embodiments, an explicit match is a direct match, wherein at least two users affirmatively defined a preference for a particular node. In still further embodiments, an explicit match is a direct to ether match, wherein one user affirmatively defined a preference for a particular node and another user has a preference for the node in ether. In still further embodiments, an explicit match is an ether to ether match, wherein at least two users have a preference for the node in ether. In some embodiments, different types of explicit matching are weighted differently by a recommendation module in applying an algorithm to make recommendations. By way of non-limiting example, direct matches are weighted more than direct to ether matches are which are in turn weighted more than ether to ether matches. By way of further non-limiting example, direct matches are weighted lx, direct to ether matches are weighted 0.75x, and ether to ether matches are weighted. 5×.

In some embodiments, suitable matches include metadata matches, wherein at least two users affirmatively defined different nodes that have some metadata in common. In some embodiments, suitable matches include neighboring nodes matches, wherein at least two users defined two different nodes that have a certain number of instances of appearing as neighbors to one another within sets of nodes in a particular domain or topic of individual users.

Various suitable embodiments utilize 1, 2, 3, more or all of the types of the classes and/or types of matches disclosed herein. While some of the embodiments described herein utilize explicit matching, many types of user preference matches are suitable. In embodiments, further utilizing non-explicit matches, application of the algorithm is the same, only the node weighting changes to reflect the power or correlative value of the particular type of match.

In some embodiments, a recommendation module responds to a request by applying a 5-step algorithm to use explicit node matches in a specified non-target domain with preferences of other users to generate a recommendation in a target domain. By way of non-limiting example, where a first user requests a recommendation for a bar in Manhattan based on her taste in music, a 5-step explicit match algorithm includes the following steps:
STEP 1: Index users who have defined one or more nodes (e.g., preferences, tastes, likes, etc.) under “bar in Manhattan” (e.g., target domain/topic) these are the potential crosses.
STEP 2: Count total number of music nodes (e.g., nodes in non-target domain) of the user requesting the recommendation.
STEP 3: Rank users indexed in STEP 1 based on how many nodes they have in common with the requesting users in the music domain (e.g., non-target domain). An optional refinement on this step includes ranking users indexed in STEP 1 based on how many does they have in common as a proportion of their total nodes.
STEP 4: Compile results of STEP 1 (e.g., nodes each indexed user has defined under “bar in Manhattan,” the target domain/topic) and weight each by the ranking of STEP 3.
STEP 5: Add each instance of a weighted node and list the top recommendations.

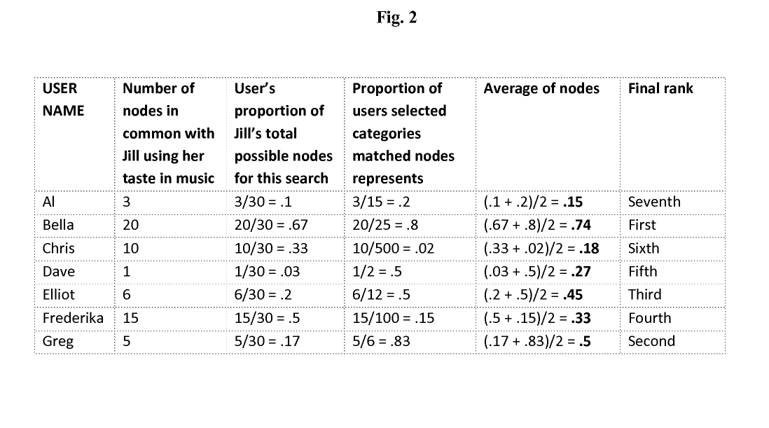

Referring to FIG. 2, depicted is an embodiment of an application of STEPS 1-3 of the exemplary algorithm described herein. Continuing with the non-limiting example, where a first user requests a recommendation for a bar in Manhattan based on her taste in music, seven users are indexed who have defined one or more nodes under “bar in Manhattan” (e.g., target domain/topic). In this embodiment, for each indexed user, the number of music nodes (e.g., nodes in non-target domain) in common with the requesting user is determined. Further in this embodiment, for each indexed user the number of music nodes in common is divided by the requesting user's total music nodes. Similarly, for each indexed user the number of music nodes in common is divided by the indexed user's total music nodes. In this embodiment, these two proportions are averaged to determine a weight and the indexed users ranked based on weight.

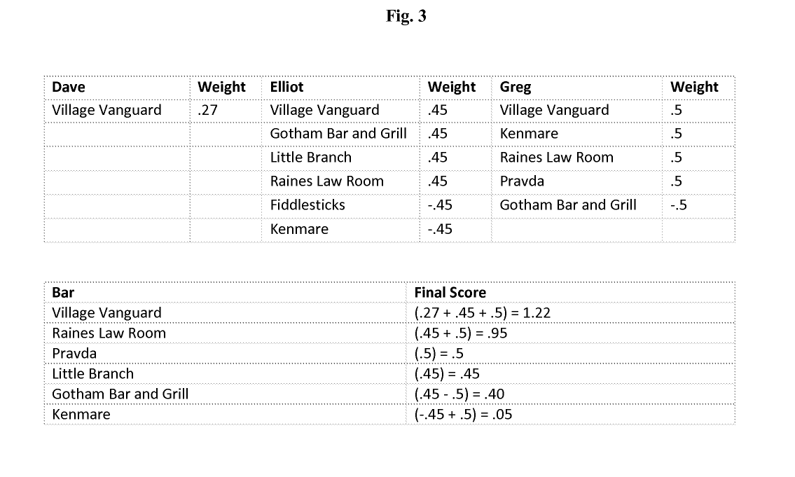

Referring to FIG. 3, depicted is an embodiment of an application of STEP 4 of the exemplary algorithm described herein. Continuing with the non-limiting example, where a first user requests a recommendation for a bar in Manhattan based on her taste in music, each of the nodes defined in the target domain are weighted based on the user rank of STEP 3 and the weights summed to generate a range of scored recommendations. In this case, the top recommendation for a bar in Manhattan based on the requesting user's taste in music is “Village Vanguard.”

Continuing to refer to FIG. 3, some nodes defined in the target domain are negatively weighted based on the user rank of STEP 3 because, in this embodiment, the nodes are aversions (e.g., dislikes) of the indexed user.

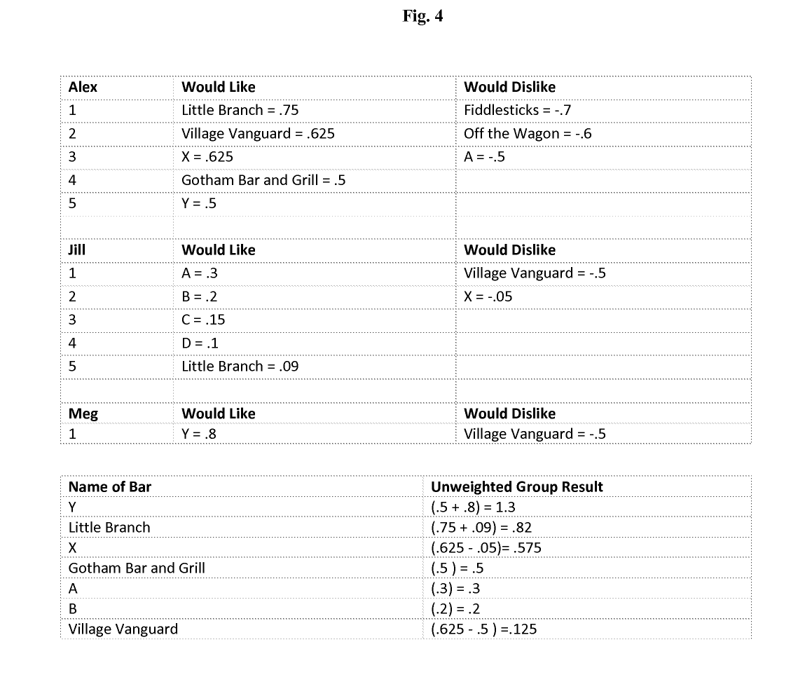

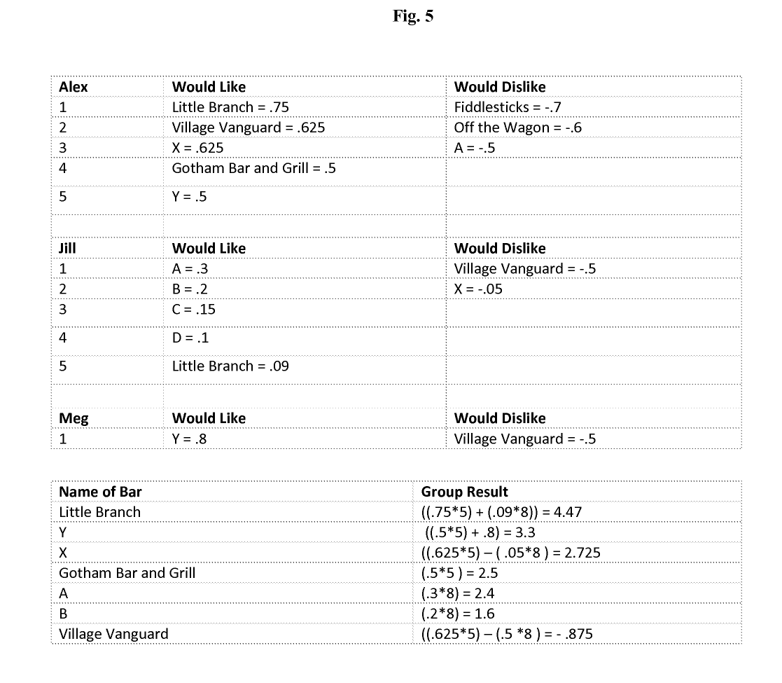

Referring to FIGS. 4 and 5, depicted is an embodiment of an application of a request for one or more recommendations in a target domain using averaged preferences defined in the profiles of a defined group of three users. FIG. 4 is an unweighted group query where each member of the group contributes to the recommendation equally. FIG. 5 is a weighted group query where each member of the group contributes to the recommendation in proportion to an assigned factor.

In some embodiments, one or more steps in an algorithm to make one or more recommendations in a target domain using preferences defined in one or more non-target domains includes screen and/or filtering information based on location. For example, if a requested recommendation and/or a target domain is location specific, the users indexed in STEP 1 of the exemplary algorithm are optionally filtered based on location information. Alternatively, for example, if a requested recommendation and/or a target domain is location specific, the weighted nodes of STEP 5 of the exemplary algorithm are optionally filtered based on location information (e.g., metadata regarding location). Many location screening/filtering parameters are suitable including, radius-based parameters, zip code-based parameters, city-based parameters, state-based parameters, and country-based parameters.

### Display Module

The systems, platforms, networks, applications, and methods described herein, in some embodiments, include a display module for presenting recommendations to a user in response to a query. In various embodiments, a display module presents at least 1, 2, 3, 4, 5, 6, 7, 8, 9, 10, 11, 12, 13, 14, 15, 16, 17, 18, 19, 20 or more recommendations to a user in response to a query. In various further embodiments, a display module presents at least 20, 30, 40, 50, 60, 70, 80, 90, 100 or more recommendations, including increments therein, to a user in response to a query. In some embodiments, a display module presents the top results from a recommendation module. In various embodiments, a display module presents the top 1, 2, 3, 4, 5, 6, 7, 8, 9, or 10 results from a recommendation module. In further embodiments, a display module presents recommendations in order of descending strength, weight, or confidence.

In some embodiments, a display module presents recommendations to a user in a list form. In other embodiments, a display module presents recommendations to a user in a map form. In further embodiments, one or more recommendations are associated with a particular location. When one or more recommendations is associated with a particular location and a display module presents recommendations to a user in a list form, the list optionally includes location information such as a link to a map, latitude/longitude information, intersection information, a photograph, or the like.

### Digital Processing Device

The systems, platforms, networks, applications, and methods described herein, in some embodiments, include a digital processing device, or use of the same. The digital processing device includes one or more hardware central processing units (CPU) that carry out the device's functions. The digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, and video game consoles. In view of the disclosure provided herein, those of skill in the art will recognize that many smartphones are suitable for use in the system described herein. In view of the disclosure provided herein, those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. In view of the disclosure provided herein, those of skill in the art will recognize that suitable server operating systems include, by way of non-limiting examples, FreeBSD, OpenBSD, NetBSD°, Linux, Apple® Mac OS X Server®, Oracle® Solaris®, Windows Server®, and Novell® NetWare®. In view of the disclosure provided herein, those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. In view of the disclosure provided herein, those of skill in the art will also recognize that suitable mobile smart phone operating systems include, by way of non-limiting examples, Nokia® Symbian® OS, Apple iOS°, Research In Motion® BlackBerry OS®, Google® Android®, Microsoft® Windows Phone® OS, Microsoft® Windows Mobile® OS, Linux °, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the systems, platforms, networks, applications, and methods disclosed herein include one or more non-transitory computer readable storage media encoded with a program including instructions executable by the operating system of a digital processing device. In further embodiments, a computer readable medium is a tangible component of a digital processing device. In still further embodiments, a computer readable medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, platforms, networks, applications, and methods disclosed herein include at least one computer program. A computer program includes a sequence of instructions, executable in the digital processing device's CPU, written to perform a specified task. In view of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In various embodiments, a computer program comprises a file, a section of code, a programming object, a programming structure, or combinations thereof. In further various embodiments, a computer program comprises a plurality of files, a plurality of sections of code, a plurality of programming objects, a plurality of programming structures, or combinations thereof. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In view of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. In view of the disclosure provided herein, those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, or Tcl. In some embodiments, a web application is written to some extent in a database query language such as Structured Query Language (SQL).

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

In view of the disclosure provided herein, those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

The systems, platforms, networks, applications, and methods disclosed herein include, in various embodiments, software, server, and database modules. In view of the disclosure provided herein, software modules are created by techniques known to those of skill in the art using machines, software, and languages known to the art. The software modules disclosed herein are implemented in a multitude of ways. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### EXAMPLES

The following illustrative examples are representative of embodiments of the software applications, systems, and methods described herein and are not meant to be limiting in any way.

### Example 1

A user employs a personalized, cross-domain recommender as described herein that is implemented as a web application. She accesses the web application with her tablet computer's web browser and defines her top three preferences in each of three domains: music, art, and books. She requests a recommendation for films based on her preferences in music and art. She is presented with a list of ten films in descending strength of recommendation.

### Example 2

A user employs a personalized, cross-domain recommender as described herein that is implemented as a mobile application. The user downloads a recommender application from an online application store and installs it on his smartphone. He executes the mobile application and defines his top five preferences in each of four domains: TV shows, restaurants, travel destinations, and fashion brands. He requests a recommendation for restaurants based on his preferences in TV shows. He is presented with a map of his location indicating five recommended restaurants and their respective locations.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented system comprising:
a. a digital processing device comprising an operating system configured to perform executable instructions and a memory device;
b. a computer program including instructions executable by the digital processing device to create a personalized, cross-domain recommender comprising:
i. a profile module for allowing a user to define preferences in a plurality of domains;
ii. a query module for allowing a user to request a recommendation in a target domain;
iii. a recommendation module for responding to a request by applying an algorithm to make one or more recommendations in said target domain using preferences defined in one or more non-target domains; and
iv. a display module for presenting said one or more recommendations to a user.

2. The system of claim 1, wherein the profile module allows a user to define preferences by providing one or more nodes in each domain.

3. The system of claim 2, wherein the nodes include metadata that enables indirect associations of preferences across domains.

4. The system of claim 3, wherein the metadata comprises an association between two or more nodes within a domain.

5. The system of claim 1, wherein the profile module accesses user information from one or more external websites or networks to define preferences in each domain.

6. The system of claim 5, wherein the profile module accesses user likes and dislikes from one or more external social networks to define preferences in each domain.

7. The system of claim 1, wherein the recommendation module responds to a request by making one or more recommendations in the target domain using preferences defined in at least two non-target domains of a querying user.

8. The system of claim 1, wherein the recommendation module responds to a request by making one or more recommendations in the target domain using averaged preferences defined in the profiles of a defined group of users.

9. The system of claim 1, wherein the recommendation module responds to a request by making one or more recommendations in the target domain using preferences defined in the profile a user connected to a querying user.

10. The system of claim 1, wherein the profile module allows a user to define preferences in a plurality of domains for one or more aliases.

11. The system of claim 10, wherein the recommendation module responds to a request by making one or more recommendations in the target domain using preferences defined in an alias for a querying user.

12. The system of claim 1, wherein the recommendation module responds to a request by making one or more recommendations filtered or sorted based on a querying user's location.

13. The system of claim 1, wherein the personalized, cross-domain recommender is implemented as a web application.

14. The system of claim 1, wherein the personalized, cross-domain recommender is implemented as a mobile application.

15. Non-transitory computer readable storage media encoded with a computer program including instructions executable by a digital processing device to create a personalized, cross-domain recommender comprising:
a. a profile module for allowing a user to define preferences in a plurality of domains;
b. a query module for allowing a user to request a recommendation in a target domain;
c. a recommendation module for responding to a request by applying an algorithm to make one or more recommendations in the target domain using preferences defined in one or more non-target domains; and
d. a display module for presenting the one or more recommendations to a user.

16. The media of claim 15, wherein the profile module allows a user to define preferences by providing one or more nodes in each domain.

17. The media of claim 16, wherein the nodes include metadata that enables indirect associations of preferences across domains.

18. The media of claim 15, wherein the profile module accesses user information from one or more external websites or networks to define preferences in each domain.

19. The media of claim 18, wherein the profile module accesses user likes and dislikes from one or more external social networks to define preferences in each domain.

20. The media of claim 15, wherein the recommendation module responds to a request by making one or more recommendations in the target domain using preferences defined in at least two non-target domains of a querying user.

21. The media of claim 15, wherein the recommendation module responds to a request by making one or more recommendations in the target domain using averaged preferences defined in the profiles of a defined group of users.

22. The media of claim 15, wherein the recommendation module responds to a request by making one or more recommendations in the target domain using preferences defined in the profile a user connected to a querying user.

23. The media of claim 15, wherein the profile module allows a user to define preferences in a plurality of domains for one or more aliases.

24. The media of claim 23, wherein the recommendation module responds to a request by making one or more recommendations in the target domain using preferences defined in an alias for a querying user.

25. The media of claim 15, wherein the personalized, cross-domain recommender is implemented as a web application.

26. The media of claim 15, wherein the personalized, cross-domain recommender is implemented as a mobile application.
